(19) United States
(12) Patent Application Publication
(10) Pub. No.: US 2010/0042949 A1
(43) Pub. Date: Feb. 18, 2010

(54) MENU MANAGEMENT SYSTEM AND METHOD

(75) Inventor: MING-HAO CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/430,121

(22) Filed: Apr. 27, 2009

(30) Foreign Application Priority Data
Aug. 13, 2008 (CN) 200810303745.X

(51) Int. Cl. G06F 3/048

(52) U.S. Cl. 715/811

(57) ABSTRACT

A computer-based menu management system and method creates a record for each of the menu options in a main menu of an electronic device, creates a sub-record for each of sub-menu options in a low hierarchy of each of the menu options, and assigns initial values to parameters of each record and each sub-record. The system and method further adds a predetermined value to each of the parameters of each record or each sub-record, in response to each visit to a corresponding menu option or a corresponding sub-menu option. In addition, the system and method totals current values of the parameters, and sorts the menu options and sub-menu options of each of the menu options according to the current values of the parameters of each record and each sub-record in a predetermined sorting period.

### BACKGROUND

1. Technical Field

Embodiments of the present disclosure are related to data management, and particularly to a menu management system and method of electronic devices.

2. Description of Related Art

Electronic devices, such as mobile phones, increasingly provide more and more functions. As a result, menu options and sub-menu options of the electronic devices also become more and more complicated. At present, display sequences of the menu options and the sub-menu options are fixed. In order to search a desired menu option or a sub-menu option, one commonly used method is to scroll through the menu options or the sub-menu options displayed on a screen one by one, until the desired menu option or sub-menu option occurs. If the desired menu option or sub-menu option is frequently used but is set at the later part of the display sequence, this method may cause inconvenience to users of the electronic devices.

### BRIEF DESCRIPTION OF THE DRAWINGS

FIG. 1 is a block diagram of one embodiment of a system for managing menus of an electronic device.

FIG. 2 is a flowchart of one embodiment of a method of managing menus of an electronic device.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

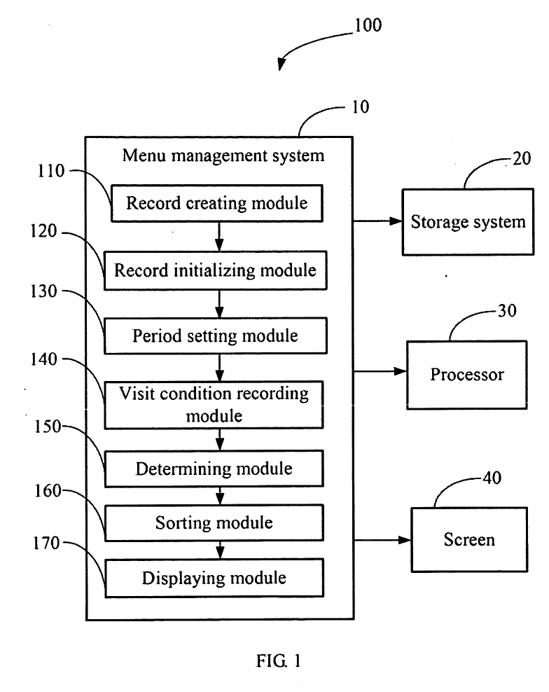

FIG. 1 is a block diagram of one embodiment of a menu management system 10 for managing menus of an electronic device 100. In one embodiment, the electronic device 100 includes a storage system 20, a processor 30, and a screen 40. The storage system 20 stores one or more programs, such as computerized codes of the menu management system 10, programs of an operating system, and other applications of the electronic device 100. In one embodiment, the electronic device may be a mobile phone or a personal digital assistant, and the storage system 20 may be an external storage card, e.g., a smart media card, a secure digital card, a compact flash card, or any other type of memory card. The processor 30 executes programs of the menu management system 10 and the other applications, to provide functions of the electronic device 100. The screen 40 displays selectable menu options to a user of the electronic device 100 to select, and further displays sub-menu options in a lower hierarchy of a menu option to the user if the menu option is highlighted by a cursor, thus the user may use a desired function provided by a sub-menu option. Depending on the embodiment, the screen 40 may be a liquid crystal display (LCD) or an cathode ray tube (CRT) display.

In one embodiment, the menu management system 10 includes a record creating module 110, a record initializing module 120, a period setting module 130, a visit condition recording module 140, a determining module 150, a sorting module 160, and a displaying module 170. The modules 110-170 may be used to execute one or more operations for the menu management system 10.

The record creating module 110 creates a record list for a main menu of the electronic device 100 in the storage system 20, creates a record for each menu option in the main menu, and creates a sub-record for each sub-menu option of each menu option. For example, the record creating module 110 respectively creates a record for each of the menu options “Messages,” “Recent Calls,” “PhoneBook,” “Ring Tones,” and any other menu option.

The record initializing module 120 assigns initial values to parameters of each record and each sub-record in the record list. In one embodiment, the parameters include a visit count of each menu option, a visit count of each sub-menu option, an elapsed time of each visit to each menu option, and an elapsed time of each visit to each sub-menu option. Depending on the embodiment, each of the initial values may be “0” or any other suitable numerical value. It may be understand that the elapsed time of a visit to an option means the time that a user spends on using the function provided by the option.

The period setting module 130 sets a sorting period for sorting the menu options and the sub-menu options. For example, the sorting period may be set as daily, weekly, monthly, or any other suitable time interval.

The visit condition recording module 140 detects visit conditions of each menu option and each sub-menu option, adds a predetermined value to the visit count of a menu option or a sub-menu option in response to each visit to the menu option or the sub-menu option, and records the elapsed time of the visit to the menu option or the sub-menu option. Depending on the embodiment, the predetermined value may be “1” or any other suitable numerical value.

The determining module 150 determines the visit count of each menu option and the visit count of each sub-menu option at the end of the sorting period, and adds the elapsed time of all visits (i.e., the total elapsed time) to each menu option and the elapsed time of all visits to each sub-menu option in the sorting period. For example, the determining module 150 may execute the determining and adding operation daily, weekly, or monthly.

The sorting module 160 sorts the menu options and the sub-menu options of each of the menu options according to the determined visit count of each menu option and the determined visit count of each sub-menu option, or according to the total elapsed time of all visits to each menu option and the total elapsed time of all visits to each sub-menu option in the sorting period. For example, the sorting module 160 may sort the menu options and the sub-menu options of each of the menus daily, weekly, or monthly.

The displaying module 170 displays the sorted menu options in the main menu on the screen 40 of the electronic device 100, and displays the sorted sub-menu options of a menu option on the screen 40 in response to the menu option being highlighted by a cursor.

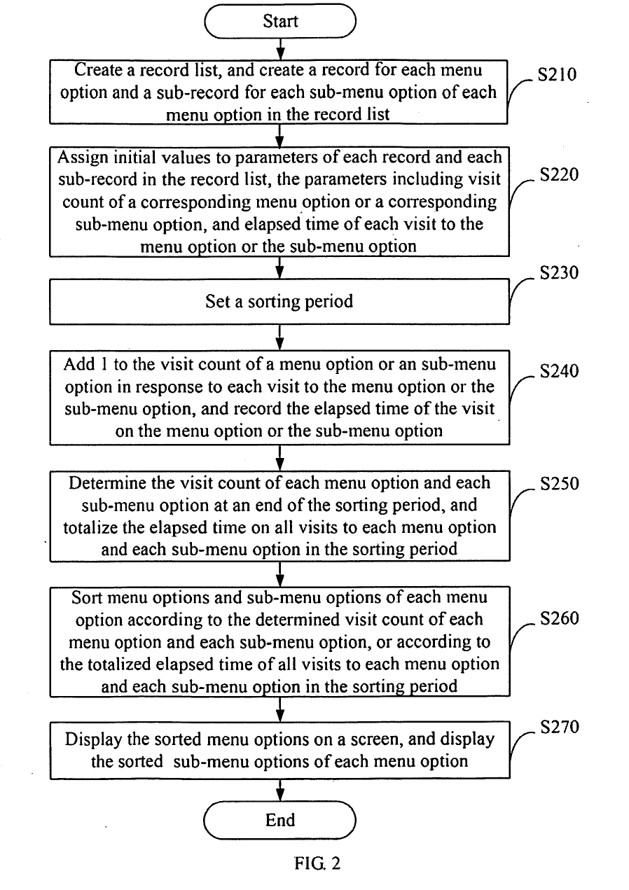

FIG. 2 is a flowchart of one embodiment of a method of managing menus of the electronic device 10. Depending on the embodiment, additional blocks may be added, others removed, and the ordering of the blocks may be changed.

In block S210, the record creating module 110 creates a record list for a main menu of the electronic device 100 in the storage system 20, creates a record for each menu option in the main menu, and creates a sub-record for each sub-menu option of each menu option. In one embodiment, for example, a record for each of the four menu options “Messages,” “Recent Calls,” “PhoneBook,” and “Ring Stones” is created. Furthermore, a sub-record for each of the five sub-menu options “Create message,” “Inbox,” “Drafts,” “Outbox,” and “Message settings” of the menu option “Messages” is created.

In block S220, the record initializing module 120 assigns initial values to parameters of each record and each sub-record in the record list. As mentioned above, the parameters include a visit count of each menu option, a visit count of each sub-menu option, an elapsed time of each visit to each menu option, and an elapsed time of each visit to each sub-menu option. For example, in this embodiment, each of the initial values is “0.” It may be understand that the elapsed time of a visit to an option means the time that a user spends on using the function provided by the option.

In block S230, the period setting module 130 sets a sorting period for sorting the menu options and the sub-menu options. For example, in this embodiment, the sorting period is set as weekly.

In block S240, the visit condition recording module 140 detects visit conditions of each menu option and each sub-menu option, adds a predetermined value to the visit count of a menu option or a sub-menu option in response to each visit to the menu option or the sub-menu option, and records the elapsed time of the visit to the menu option or the sub-menu option. For example, in this embodiment, the predetermined value is “1.”

In block S250, the determining module 150 determines the visit count of each menu option, the visit count of each sub-menu option at the end of the sorting period, and adds the elapsed time of all visits (i.e., the total elapsed time) to each menu option and the elapsed time of all visits to each sub-menu option in the sorting period. As mentioned above, in this embodiment, the determining and adding operation is executed weekly. For example, the determined visit count of the four menu options “Messages,” “Recent Calls,” “PhoneBook,” and “Ring Stones” may be “80,” “100,” “50,” and “5” in one week.

In block S260, the sorting module 160 sorts the menu options and the sub-menu options of each of the menu options according to the determined visit count of each menu option and the determined visit count of each sub-menu option, or according to the total elapsed time of all visits to each menu option and the total elapsed time of all visits to each sub-menu option in the sorting period. For example, in this embodiment, the sorting operation is executed weekly according to the determined visit count of each menu option and each sub-menu option. As mentioned above, accordingly, a sorted sequence of the four menu options “Messages,” “Recent Calls,” “PhoneBook,” and “Ring Stones” is “Recent Calls,” “Messages,” “PhoneBook,” and “Ring Stones.”

In block S270, the displaying module 170 displays the sorted menu options in the main menu on the screen 40 of the electronic device 100, and displays the sorted sub-menu options of a menu option on the screen 40 in response to the menu option being highlighted by a cursor, so that the user of the electronic device 100 can search for his favorite menu options or sub-menu options in less time. As mentioned above, accordingly, a display sequence of the four menu options “Messages,” “Recent Calls,” “PhoneBook,” and “Ring Stones” may be changed to “Recent Calls,” “Messages,” “PhoneBook,” and “Ring Stones” after the sorting operation.

The above embodiments automatically change display sequences of the options in the main menu and the options of any sub-menu based on visit conditions of the options in a predetermined period, so that frequently used options in the main menu or a sub-menu can be displayed ahead of those seldom used options, to satisfy individuation demands of different users of the same electronic device 100.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A method of managing menus of an electronic device, the method comprising:
creating a record list for the menus of the electronic device in a storage system of the electronic device, the record list comprising a record for each menu option in the menus;
assigning initial values to parameters of each record in the record list, the parameters comprising a visit count of a corresponding menu option, and an elapsed time of each visit by a user of the electronic device to the menu option;
setting a sorting period to sort the menu options;
adding a predetermined value to the visit count of a menu option in response to each visit to the menu option, and recording the elapsed time of the visit to the menu option;
determining the visit count of each menu option at an end of the sorting period, and totaling the elapsed time of all visits to each menu option in the sorting period;
sorting the menu options according to the determined visit count of each menu option, or according to the total elapsed time of all visits to each menu option in the sorting period; and
displaying the sorted menu options on a screen of the electronic device.

2. The method as claims in claim 1, wherein the menu options comprise main menu options in a main menu and sub-menu options of each main menu option.

3. The method as claims in claim 1, wherein each of the initial values is zero, and the predetermined value is one.

4. The method as claims in claim 1, wherein the storage system is selected from the group consisting of a smart media card, a secure digital card, and a compact flash card.

5. The method as claims in claim 1, wherein the electronic device is a mobile phone or a personal digital assistant.

6. A computer-based menu management system, the system comprising:
a storage system;
at least one processor; and
one or more programs stored in the storage system and being executable by the at least one processor, the one or more programs comprising:
a record creating module to create a record list for menus of the electronic device, and to create a record for each menu option in the menus;
a record initializing module to assign initial values to parameters of each record, the parameters comprising a visit count of a corresponding menu option, and an elapsed time of each visit by a user of the electronic device to the menu option;
a period setting module to set a sorting period to sort the menu options;
a visit condition recording module to add a predetermined value to the visit count of a menu option in response to each visit to the menu option, and to record the elapsed time of the visit to the menu option;
a determining module to determine the visit count of each menu option at an end of the sorting period, and to total the elapsed time of all visits to each menu option in the sorting period; and
a sorting module to sort the menu options according to the determined visit count of each menu option, or according to the total elapsed time of all visits to each menu option in the sorting period.

7. The system as claimed in claim 6, wherein the one or more programs further comprise a displaying module to display the sorted menu options on a screen of the electronic device.

8. The system as claimed in claim 6, wherein the menu options comprise main menu options in a main menu and sub-menu options of each main menu option.

9. The system as claimed in claim 6, wherein each of the initial values is zero, and the predetermined value is one.

10. The system as claimed in claim 6, wherein the storage system is selected from the group consisting of a smart media card, a secure digital card, and a compact flash card.

11. The system as claimed in claim 6, wherein the electronic device is a mobile phone or a personal digital assistant.

12. A storage medium storing a set of instructions, the set of instructions capable of being executed by a processor to perform a method of managing menus of an electronic device, the method comprising:
creating a record list for the menus of the electronic device in a storage system of the electronic device, the record list comprising a record for each menu option in the menus;
assigning initial values to parameters of each record in the record list, the parameters comprising a visit count of a corresponding menu option, and an elapsed time of each visit by a user of the electronic device to the menu option;
setting a sorting period to sort the menu options;
adding a predetermined value to the visit count of a menu option in response to each visit to the menu option, and recording the elapsed time of the visit to the menu option;
determining the visit count of each menu option at an end of the sorting period, and totaling the elapsed time of all visits to each menu option in the sorting period;
sorting the menu options according to the determined visit count of each menu option, or according to the total elapsed time of all visits to each menu option in the sorting period; and
displaying the sorted menu options on a screen of the electronic device.

13. The storage medium as claimed in claim 11, wherein the menu options comprise main menu options in a main menu and sub-menu options of each main menu option.

14. The storage medium as claimed in claim 11, wherein each of the initial values is zero, and the predetermined value is one.

15. The storage medium as claimed in claim 11, wherein the storage medium is selected from the group consisting of a smart media card, a secure digital card, and a compact flash card.

16. The storage medium as claimed in claim 11, wherein the electronic device is a mobile phone or a personal digital assistant.
